(19) United States
(12) Patent Application Publication
(10) Pub. No.: US 2023/0275214 A1
(43) Pub. Date: Aug. 31, 2023

(54) NICKEL-CONTAINING HYDROXIDE PARTICLE COVERED WITH COBALT

(71) Applicant: TANAKA CHEMICAL CORPORATION, Fukui (JP)

(72) Inventors: Naoya Hanamura, Fukui (JP); Naotoshi Satomi, Fukui (JP); Mikio Hata, Fukui (JP)

(73) Assignee: TANAKA CHEMICAL CORPORATION, Fukui (JP)

(21) Appl. No.: 18/009,103

(22) PCT Filed: May 17, 2021
(86) PCT No.: PCT/JP2021/018521

§ 371 Date: Dec. 8, 2022

(30) Foreign Application Priority Data
Jun. 18, 2020 (JP) 2020-105574

(51) Int. Cl. H01M 4/36; H01M 4/52; H01M 4/38; H01M 4/32; C01G 53/00

(52) U.S. Cl. CPC H01M 4/366; H01M 4/52; H01M 4/38; H01M 4/32; C01G 53/00; H01M 2004/021

(57) ABSTRACT

A nickel-containing hydroxide particle covered with cobalt capable of preventing cracks and fissures in the particle and fine powder from being generated due to having an excellent particle strength is provided. The nickel-containing hydroxide particle covered with cobalt, including a covering layer containing cobalt oxyhydroxide formed on a nickel-containing hydroxide particle, wherein an average particle strength is 65.0 MPa or more and 100.0 MPa or less for a particle diameter with a cumulative volume percentage of 50% by volume (D50) of 10.0 μm or larger and 11.5 μm or smaller.

### CROSS REFERENCE TO RELATED APPLICATIONS

The present application is a by-pass continuation application of International Patent Application No. PCT/JP2021/018521 filed on May 17, 2021, which claims the benefit of Japanese Patent Application No. 2020-105574, filed on Jun. 18, 2020. The contents of these applications are incorporated herein by reference in their entirety.

### BACKGROUND

### Technical Field

The present disclosure relates to a nickel-containing hydroxide particle covered with cobalt capable of preventing particle cracks and fine powder from being generated due to having an excellent particle strength and of improving battery characteristics when used as a positive electrode active material in secondary batteries.

### Background

In recent years, improvements in battery characteristics of secondary batteries such as nickel metal hydride secondary batteries, have been increasingly demanded attendant on enhanced functionality of equipment and the like. Therefore, in nickel hydroxide particles covered with a cobalt compound for positive electrode active materials of secondary batteries, a nickel-containing composite hydroxide particle with a higher cobalt content has been developed in order to improve battery characteristics.

Moreover, a covering layer with a cobalt compound is also formed on a nickel hydroxide particle in order to increase the cobalt content. As the nickel hydroxide particle having a covering layer of the cobalt compound formed thereon, for example, covered nickel hydroxide powder for positive electrode active materials of alkaline secondary batteries in which a particle surface of the nickel hydroxide powder is covered with cobalt oxyhydroxide or a cobalt compound composed mainly of a mixture of cobalt oxyhydroxide and cobalt hydroxide in order to ensure uniformity and adhesiveness of the covering layer, characterized in that the cobalt in the covering has a valence number of 2.5 or higher, and an amount of peeling of the covering is 20% by mass or less of the total covering amount when 20 g of the covered nickel hydroxide powder is shaken for 1 hour in an air-tight container, has been proposed (Japanese Patent Application Publication No. 2014-103127).

On the other hand, due to further enhanced functionality of equipment in which a secondary battery such as a nickel metal hydride secondary battery is mounted and the like, higher loads may be applied to the secondary battery mounted. When evaluating cycle characteristics of a secondary battery such as a nickel metal hydride secondary battery under high loads, cracks and fissures have developed in a positive electrode active material, which may reduce electrical conductivity of the positive electrode active material, resulting in failure to obtain excellent battery characteristics. Therefore, improvement in a particle strength of the positive electrode active material is required in order to prevent cracks and fissures of the positive electrode active material from being generated even under high loads in the secondary battery such as a nickel metal hydride secondary battery.

However, covered nickel hydroxide powder for a positive electrode active material of an alkaline secondary battery of Japanese Patent Application Publication No. 2014-103127 may cause cracks and fissures in the positive electrode active material when performing charge and discharge under high loads, and thus there has been room for improvement in increasing a particle strength as the positive electrode active material.

### SUMMARY

In view of the circumstances, it is an object of the present disclosure to provide a nickel-containing hydroxide particle covered with cobalt capable of preventing cracks and fissures in the particle and fine powder from being generated due to having an excellent particle strength.

The gist of the configuration of the present disclosure is as follows:
[1] A nickel-containing hydroxide particle covered with cobalt, including a covering layer containing cobalt oxyhydroxide formed on a nickel-containing hydroxide particle, wherein an average particle strength is 65.0 MPa or more and 100.0 MPa or less for a particle diameter with a cumulative volume percentage of 50% by volume (D50) of 10.0 μm or larger and 11.5 μm or smaller.
[2] The nickel-containing hydroxide particle covered with cobalt according to [1], wherein the covering layer containing cobalt oxyhydroxide contains cobalt oxyhydroxide in an amount of 70% by mass or more.
[3] The nickel-containing hydroxide particle covered with cobalt according to [1] or [2], wherein a volume resistivity is 0.4 Ω·cm or more and 10.0 Ω·cm or less.
[4] The nickel-containing hydroxide particle covered with cobalt according to any one of [1] to [3], wherein the nickel-containing hydroxide particle comprises zinc.
[5] The nickel-containing hydroxide particle covered with cobalt according to [4], wherein a ratio of a mass of cobalt in the nickel-containing hydroxide particle to a mass of cobalt in the covering layer containing cobalt oxyhydroxide is 0.0001 or more and 0.0239 or less.
[6] The nickel-containing hydroxide particle covered with cobalt according to [4] or [5], wherein the nickel-containing hydroxide particle contains nickel (Ni), zinc (Zn), and one or more additive metal elements M selected from the group consisting of cobalt (Co) and magnesium (Mg), and a ratio by mole of nickel:zinc:additive metal element M is 100−x−y:x:y, where 1.50≤x≤9.00 and 0.00≤y≤3.00.
[7] The nickel-containing hydroxide particle covered with cobalt according to any one of [1] to [6], which is for a positive electrode active material of a nickel metal hydride secondary battery.
[8] A positive electrode, having the nickel-containing hydroxide particle covered with cobalt according to any one of [1] to [7] and a metal foil current collector.
[9] A nickel metal hydride secondary battery including the positive electrode according to [8].

In the nickel-containing hydroxide particle covered with cobalt of the present disclosure, the nickel-containing hydroxide particle has a covering layer, and the covering layer contains a cobalt compound.

In an aspect of [1] above, the “particle strength” refers to a strength (St) obtained by applying a test pressure (load) to a nickel-containing hydroxide particle covered with cobalt, selected at random by using a microcompression tester, measuring the amount of displacement of a composite hydroxide particle, and determining a test force (P) as a pressure value at which the amount of displacement reaches the largest while the test pressure remains almost constant, upon gradually increasing the test pressure, followed by calculation by using the formula of Hiramatsu et al. (Journal of the Japan Mining Industry Association, Vol. 81, (1965)) represented by the following formula (A). The “average particle strength” refers a value calculated from an average of 10 measurements of the particle strength obtained by having performed the above-described procedure 10 times.

St=2.8×P/(π×d×d) (d: composite hydroxide particle diameter) (A)

As the microcompression tester, for example, “microcompression tester MCT-510” manufactured by Shimadzu Corporation can be included.

According to the nickel-containing hydroxide particle covered with cobalt of the present disclosure, the nickel-containing hydroxide particle covered with cobalt, having an average particle strength of 65.0 MPa or more and 100.0 MPa or less, for a particle diameter with a cumulative volume percentage of 50% by volume (D50) of 10.0 μm or larger and 11.5 μm or smaller, has an excellent particle strength, thereby enabling the nickel-containing hydroxide particle covered with cobalt to be prevented from generating cracks and fissures and also to be prevented from generating fine powder of the nickel-containing hydroxide particles. Accordingly, even when a positive electrode active material using the nickel-containing hydroxide particle covered with cobalt of the present disclosure is mounted in a secondary battery and the secondary battery undergoes high loads, the positive electrode active material can be prevented from generating cracks and fissures, resulting in being able to maintain excellent battery characteristics.

According to the nickel-containing hydroxide particle covered with cobalt of the present disclosure, the covering layer containing cobalt oxyhydroxide, containing cobalt oxyhydroxide in an amount of 70% by mass or more, can more reliably improve electrical conductivity while the nickel-containing hydroxide particle covered with cobalt has an excellent particle strength.

According to the nickel-containing hydroxide particle covered with cobalt of the present disclosure, the volume resistivity being 0.4 Ω·cm or more and 10.0 Ω·cm or less allows the electrical conductivity to be more reliably improved, as a result of which excellent battery characteristics can be obtained even when a secondary battery undergoes high loads.

According to the nickel-containing hydroxide particle covered with cobalt of the present disclosure, a ratio of a mass of cobalt in the nickel-containing hydroxide particle to a mass of cobalt in the covering layer containing cobalt oxyhydroxide being 0.0001 or more and 0.0239 or less enables the particle strength and the electrical conductivity to more reliably be improved in a favorable balanced manner.

### DETAILED DESCRIPTION

Hereinafter, the nickel-containing hydroxide particle covered with cobalt of the present disclosure will be described in detail. In the nickel-containing hydroxide particle covered with cobalt of the present disclosure, a covering layer of a cobalt compound is formed on a surface of the nickel-containing hydroxide particle. Namely, the nickel-containing hydroxide particle is a core particle, and the core particle is covered with a layer of the cobalt compound, for example, a layer of a cobalt compound in which cobalt mainly has a valence number of 3. The cobalt compounds in which cobalt has a valence number of 3 include cobalt oxyhydroxide. From the above, the nickel-containing hydroxide particle covered with cobalt of the present disclosure is a particle in which a covering layer containing cobalt oxyhydroxide is formed on the nickel-containing hydroxide particle.

A shape of the nickel-containing hydroxide particle covered with cobalt is not particularly limited, but includes, for example, a substantially spherical shape. Moreover, the nickel-containing hydroxide particle is, for example, in the form of secondary particles formed of aggregated plural primary particles. A covering layer containing cobalt oxyhydroxide of the nickel-containing hydroxide particle covered with cobalt may cover the entire surface of the nickel-containing hydroxide particle or may cover a partial region of a surface of the nickel-containing hydroxide particle.

In the nickel-containing hydroxide particle covered with cobalt of the present disclosure, an average particle strength is in the range of 65.0 MPa or more and 100.0 MPa or less for a particle diameter with a cumulative volume percentage of 50% by volume (D50) (hereinafter, may be simply referred to as “D50”) of 10.0 μm or larger and 11.5 μm or smaller. The nickel-containing hydroxide particle covered with cobalt has such an excellent particle strength of 65.0 MPa or more thereby enables the nickel-containing hydroxide particle covered with cobalt to be prevented from generating cracks and fissures and also to be prevented from generating fine powder of the nickel-containing hydroxide particles. Accordingly, even when a positive electrode active material using the nickel-containing hydroxide particle covered with cobalt of the present disclosure is mounted in a secondary battery and the secondary battery undergoes high loads, the positive electrode active material can be prevented from generating cracks, fissures, and the fine powder, thereby enabling to maintain the excellent electrical conductivity, resulting in being able to maintain excellent battery characteristics. Further, the nickel-containing hydroxide particle covered with cobalt, having an average particle strength of 100.0 MPa or less for D50 of the nickel-containing hydroxide particle with cobalt of 10.0 μm or larger and 11.5 μm or smaller thereby enables an electrolytic solution to smoothly permeate into a positive electrode active material using the nickel-containing hydroxide particle covered with cobalt of the present disclosure. Therefore, the excellent battery characteristics can be maintained.

The average particle strength for D50 of 10.0 μm or larger and 11.5 μm or smaller of the nickel-containing hydroxide particle covered with cobalt, is not particularly limited as long as the average particle strength is 65.0 MPa or more and 100.0 MPa or less, but the lower limit value thereof is preferably 68.0 MPa and particularly preferably 70.0 MPa from the viewpoint of reliably preventing cracks, fissures and fine powder from being generated in the nickel-containing hydroxide particle covered with cobalt. On the other hand, the upper limit value of the average particle strength for D50 of 10.0 μm or larger and 11.5 m or smaller of the nickel-containing hydroxide particle covered with cobalt is preferably 95.0 MPa and particularly preferably 90.0 MPa from the viewpoint of enabling an electrolytic solution to smoothly permeate into the positive electrode active material. The above-described upper limit values and lower limit values can arbitrarily be combined.

The content of cobalt oxyhydroxide in the covering layer containing the cobalt oxyhydroxide is not particularly limited, but the lower limit value thereof is preferably 70% by mass and particularly preferably 80% by mass from the viewpoint of more reliably improving the electrical conductivity while having the excellent particle strength. Moreover, the higher the upper limit value of the content of cobalt oxyhydroxide in the covering layer containing cobalt oxyhydroxide, more preferred the upper limit value will be, and a covering layer composed of cobalt oxyhydroxide (content of cobalt oxyhydroxide of approximately 100% by mass) is particularly preferred. The covering layer containing cobalt oxyhydroxide may inevitably contain cobalt oxide in addition to cobalt oxyhydroxide, in a production step.

The nickel-containing hydroxide particle covered with cobalt of the present disclosure has volume resistivity of 10.0 Ω·cm or less. The volume resistivity being 10.0 Ω·m or less allows the electrical conductivity of the nickel-containing hydroxide particle covered with cobalt to more reliably be improved, whereby electrical conductivity of a positive electrode active material is maintained even when high loads are applied to a secondary battery, thereby enabling excellent battery characteristics to be obtained.

The volume resistivity of the nickel-containing hydroxide particle covered with cobalt is not particularly limited as long as the volume resistivity is 10.0 Ω·cm or less, but the volume resistivity is preferably 7.5 Ω·cm or less and particularly preferably 5.0 Ω·cm or less from the viewpoint of further improving the electrical conductivity. The lower limit value of the volume resistivity of the nickel-containing hydroxide particle covered with cobalt is, on the other hand, preferably as low as possible. The lower limit values of the volume resistivity of the nickel-containing hydroxide particle covered with cobalt include, for example, 0.4 Ω·cm.

A composition of the nickel-containing hydroxide particle that is a core particle, is not limited as long as the nickel-containing hydroxide particle is a particle of hydroxide containing nickel, but the composition preferably contains zinc (Zn) from the viewpoint of obtaining a high utilization rate and excellent charge/discharge characteristics. Moreover, the zinc is preferably contained in the form of solid-solubilized zinc. Namely, the nickel-containing hydroxide particle that is the core particle is preferably a nickel hydroxide particle in which zinc is solid-solubilized, i.e., a nickel-containing composite hydroxide particle.

The nickel-containing hydroxide particle that is the core particle may undergo solid solution formation with not only zinc (Zn), but also further cobalt (Co) or magnesium (Mg), if necessary, in terms of prolonging a life of the nickel-containing hydroxide particle.

In a case in which the nickel-containing hydroxide particle contains solid solubilized cobalt, at least a moiety of the solid solubilized cobalt is preferably trivalent cobalt in terms of the electrical conductivity of the nickel-containing hydroxide particle. The trivalent cobalt solid-solubilized in the nickel-containing hydroxide particle includes, for example, cobalt oxyhydroxide.

The ratio of the mass of cobalt in the nickel-containing hydroxide particle that is the core particle to the mass of cobalt in the covering layer containing cobalt oxyhydroxide is not particularly limited, but the lower limit value of the ratio is preferably 0.0001 and particularly preferably 0.0010 in terms of ensuring conductivity. The upper limit value of the above-described ratio is, on the other hand, preferably 0.0239 in terms of more reliably improving the particle strength and electrical conductivity in a balanced manner. It is noted that the above-described upper limit values and lower limit values can arbitrarily be combined. Therefore, the nickel-containing hydroxide particle covered with cobalt of the present disclosure preferably has a ratio of the mass of cobalt in the nickel-containing hydroxide particle to the mass of cobalt in the covering layer, which is lowered compared to those of conventional nickel-containing hydroxide particles covered with cobalt.

The nickel-containing hydroxide particle that is the core particle include, for example, a nickel-containing hydroxide particle containing nickel (Ni) and zinc (Zn), and one or more additive metal elements M selected from the group consisting of cobalt (Co) and magnesium (Mg), and the ratio by mole of nickel:zinc:additive metal element M is 100−x−y:x:y (where 1.50≤x≤9.00, 0.00≤y≤3.00). Additive metal element M is solid solubilized in the nickel-containing hydroxide particle.

The cobalt oxyhydroxide contained in the covering layer has a diffraction peak between 650 and 66° of diffraction angles represented by 20 in a diffraction pattern obtained by X-ray diffraction measurement.

The content of nickel in the nickel-containing hydroxide particle in the nickel-containing hydroxide particle covered with cobalt is not particularly limited, but the lower limit value thereof is preferably 40% by mass, more preferably 45% by mass, and particularly preferably 50% by mass. The upper limit value of the content of nickel in the nickel-containing hydroxide particle in the nickel-containing hydroxide particle covered with cobalt is, on the other hand, preferably 65% by mass and particularly preferably 60% by mass. The lower limit values and the upper limit values described above can arbitrarily be combined.

The average particle diameter of the nickel-containing hydroxide particle covered with cobalt is not particularly limited, but for example, the lower limit value of D50 is preferably 4.0 m and more preferably 6.0 μm in terms of reliably obtaining the excellent particle strength, and particularly preferably 9.0 μm in terms of reliably obtaining further excellent particle strength. The upper limit value of D50 of the nickel-containing hydroxide particle covered with cobalt is, on the other hand, preferably 15.0 μm and particularly preferably 12.5 μm from the viewpoint of balance between improvements in density and securing of a contact surface with an electrolytic solution. The lower limit values and the upper limit values described above can arbitrarily be combined.

The BET specific surface area of the nickel-containing hydroxide particle covered with cobalt is not particularly limited, but the lower limit value thereof is preferably 5.0 m²/g and particularly preferably 10.0 m²/g from the viewpoint of balance between improvements in density and securing of a contact surface with the electrolytic solution. The upper limit value of the BET specific surface area of the nickel-containing hydroxide particle covered with cobalt is, on the other hand, preferably 25.0 m²/g and particularly preferably 20.0 m²/g in terms of reliably obtaining the excellent particle strength. The lower limit values and the upper limit values described above can arbitrarily be combined.

The tap density of the nickel-containing hydroxide particle covered with cobalt is not particularly limited, but is preferably 1.5 g/cm³ or more and particularly preferably 1.7 g/cm³ or more from the viewpoint of, for example, improvements in the filling degree in using the particle in a positive electrode as a positive electrode active material.

The bulk density of the nickel-containing hydroxide particle covered with cobalt is not particularly limited, but is preferably 0.8 g/cm³ or more, and particularly preferably 1.0 g/cm³ or more from the viewpoint of, for example, improvements in the filling degree in using the particle in a positive electrode as a positive electrode active material.

The nickel-containing hydroxide particle covered with cobalt of the present disclosure can be used, for example, as a positive electrode active material for nickel metal hydride secondary batteries.

Thereafter, examples of a method for producing the nickel-containing hydroxide particle covered with cobalt of the present disclosure will be described.

Examples of the method for producing the nickel-containing hydroxide particle covered with cobalt of the present disclosure include a step of preparing a suspension (for example, a water suspension) containing the nickel-containing hydroxide particle that is the core particle, a covering step of supplying the suspension containing the nickel-containing hydroxide particle with a cobalt salt solution and an alkali solution and forming a covering layer containing cobalt on a surface of the nickel-containing hydroxide particle to obtain a nickel-containing hydroxide particle having the covering layer formed thereon, and an oxidation step of adding an alkali solution to dried powder of the nickel-containing hydroxide particle having the covering layer formed thereon, which was obtained by having subjected the nickel-containing hydroxide particle having the covering layer formed thereon to drying treatment, mixing the mixture and supplying an air containing oxygen while heating to oxidize cobalt contained in the covering layer.

<Preparation Step of Suspension Containing Nickel-Containing Hydroxide Particle>

A method for preparing a suspension containing the nickel-containing hydroxide particle that is the core particle will be described below. Here, an example of a method for preparing a suspension containing a nickel-containing hydroxide particle in which zinc and additive metal element M are solid-solubilized in the particle will be described. First, a salt solution (for example, a sulfate solution) of nickel, zinc, and additive metal element M, and a complexing agent are reacted by a coprecipitation method to produce a nickel-containing hydroxide particle and to obtain a slurry suspension containing the nickel-containing hydroxide particle. As a solvent for the suspension, for example, water is used as described above.

The complexing agent is not particularly limited as long as the complexing agent can form a complex with nickel, zinc, and an ion of additive metal element M described above in an aqueous solution, and examples thereof include, for example, ammonium ion-supplying bodies (such as ammonium sulfate, ammonium chloride, ammonium carbonate, and ammonium fluoride), hydrazine, ethylenediaminetetraacetic acid, nitrilotriacetic acid, uracildiacetic acid, and glycine. If necessary, an alkali metal hydroxide (for example, sodium hydroxide or potassium hydroxide) is added in order to adjust the pH value of the aqueous solution in performing precipitation.

When the complexing agent is supplied continuously into a reaction tank in addition to the above-described salt solution, nickel, zinc and additive metal element M undergo crystallization reaction and the nickel-containing hydroxide particle is produced. In performing the crystallization reaction, the substances in the reaction tank are stirred appropriately while the temperature of the reaction tank is controlled within the range of, for example, 10° C. to 80° C., preferably 20 to 70° C., and the pH value in the reaction tank is controlled within the range of, for example, a pH of 9 to a pH of 13 and preferably a pH of 11 to a pH of 13 at a liquid temperature of 25° C. as a standard. Examples of the reaction tank include a continuous type to allow the formed hydroxide particle containing nickel to overflow for the purpose of separation.

<Covering Step>

Thereafter, to the suspension containing nickel-containing hydroxide particles were added a cobalt salt solution (such as, an aqueous solution of cobalt sulfate), an alkali solution (such as an aqueous solution of sodium hydroxide), and the above-described complexing agent (such as ammonium sulfate solution) with as little stirring as possible to the extent that the nickel-containing hydroxide particles are curled up using a stirrer, to form a covering layer composed mainly of a cobalt compound such that a valence number of cobalt is 2, such as cobalt hydroxide, on a surface of the nickel-containing hydroxide particle by neutralization crystallization. The pH value in the step of forming the above-described covering layer is preferably maintained within the range of 9 to 13 at a liquid temperature of 25° C. as a standard. The covering step above allows a nickel-containing hydroxide particle having a covering layer containing cobalt formed thereon to be obtained. The nickel-containing hydroxide particle having a covering layer containing cobalt formed thereon can be obtained as a slurry suspension.

<Solid Liquid Separation Treatment>

Moreover, before an oxidation step, a step of separating the suspension containing the nickel-containing hydroxide particle having a covering layer containing cobalt formed thereon into a solid phase and a liquid phase and drying the solid phase separated from the liquid phase to obtain dried powder of the nickel-containing hydroxide particle having a covering layer containing cobalt formed thereon, may be further included, as necessary. In addition, before drying the solid phase, the solid phase may be washed with weak alkaline water, if necessary.

<Oxidation Step>

Thereafter, an oxidation treatment is performed on the nickel-containing hydroxide particle having a covering layer containing cobalt formed thereon. Methods of the oxidation treatment include a method for adding an alkali solution such as a 48% by mass sodium hydroxide aqueous solution to the dried powder containing the nickel-containing hydroxide particles, mixing and heating them. The above-described oxidation treatment enables divalent cobalt in the nickel-containing hydroxide particle having a covering layer containing cobalt formed thereon to be oxidized to be cobalt oxyhydroxide that is trivalent cobalt. Oxidation of the divalent cobalt in the covering layer to cobalt oxyhydroxide enables the nickel-containing hydroxide particle covered with cobalt of the present disclosure having a covering layer containing cobalt oxyhydroxide formed on the particle to be obtained.

Thereafter, a positive electrode using the nickel-containing hydroxide particle covered with cobalt of the present disclosure and a secondary battery using the positive electrode will be described. Here, a nickel metal hydride secondary battery will be used as an example of the secondary battery. The nickel metal hydride secondary battery is provided with a positive electrode using the above-described nickel-containing hydroxide particle covered with cobalt of the present disclosure, a negative electrode, an alkaline electrolytic solution, and a separator.

The positive electrode is provided with a positive electrode collector and a positive electrode active material layer formed on a surface of the positive electrode collector. The positive electrode active material layer has the nickel-containing hydroxide particle covered with cobalt, a binder (binding agent), and, if necessary, a conductive assistant. The conductive assistant is not particularly limited as long as the conductive assistant can be used for a nickel metal hydride secondary battery, but, for example, metal cobalt, cobalt oxide, and the like can be used. The binder is not particularly limited, but examples thereof include polymer resins, such as, for example, polyvinylidene difluoride (PVdF), butadiene rubber (BR), polyvinyl alcohol (PVA), and carboxymethyl cellulose (CMC), polytetrafluoroethylene (PTFE), and combinations thereof. The positive electrode collector is not particularly limited, but examples thereof include a perforated metal, an expanded metal, wire netting, a foam metal such as a foam nickel, a mesh-like metal fiber sintered body, a metal-plated resin sheet, a metal foil.

As a method for producing the positive electrode, for example, a positive electrode active material slurry is first prepared by mixing the nickel-containing hydroxide particle covered with cobalt, a conductive assistant, a binder, and water. Subsequently, the positive electrode collector is filled with the positive electrode active material slurry by a known filling method, and the positive electrode active material slurry is dried, and then rolled and fixed with a press or the like.

The negative electrode is provided with a negative electrode collector and a negative electrode active material layer containing a negative electrode active material, the layer formed on a surface of the negative electrode collector. The negative electrode active material is not particularly limited as long as the negative electrode active material is usually used, and, for example, a hydrogen storage alloy particle can be used. As the negative electrode collector, electrically conductive metal materials, such as nickel, aluminum, and stainless steel, which are the same materials as the positive electrode collector, can be used.

Moreover, if necessary, a conductive assistant, a binder, or the like may be further added in the negative electrode active material layer. Examples of the conductive assistant and the binder include the conductive assistants and the binders which are the same as those used in the positive electrode material layer.

As a method for producing the negative electrode, for example, a negative electrode active material slurry is first prepared by mixing a negative electrode active material, water, and if necessary, a conductive assistant and a binder. Subsequently, the negative electrode collector is filled with the negative electrode active material slurry by a known filling method, and the negative electrode active material slurry is dried, and then rolled and fixed with a press or the like.

In the alkaline electrolytic solution, examples of the solvent include water, and examples of the solute to be dissolved in the solvent include potassium hydroxide and sodium hydroxide. The solutes may be used singly, or two or more thereof may be used together.

The separator is not particularly limited, but examples thereof include polyolefin nonwoven fabric, such as polyethylene nonwoven fabric and polypropylene nonwoven fabric, polyamide nonwoven fabric, and those obtained by having performed a hydrophilic treatment thereon.

### EXAMPLES

Thereafter, Examples of the present disclosure will be described, but the present disclosure is not limited to these Examples unless deviating from the scope thereof.

### Example 1

Synthesis of Nickel-Containing Hydroxide Particle, in which Zinc was Solid-Solubilized

An ammonium sulfate aqueous solution (complexing agent) and a sodium hydroxide aqueous solution were dropped into an aqueous solution obtained by dissolving zinc sulfate and nickel sulfate in a predetermined ratio, and the resultant mixture was stirred continuously with a stirrer while the pH in the reaction tank was maintained at 12.0 at a liquid temperature of 25° C. as a standard. A produced hydroxide was allowed to overflow from an overflow pipe of the reaction tank and was taken out. Each treatment of washing with water, dehydration, and drying was performed on the hydroxide which was taken out to obtain a nickel-containing hydroxide particle, in which zinc was solid-solubilized.

Formation of Covering Layer Containing Cobalt

After putting an aqueous solution of ammonium sulfate that is the complexing agent into a 15 L reaction tank so that the concentration of ammonia in the reaction tank was 5 to 13 g/L, to an alkali aqueous solution in the reaction tank the pH of which was maintained in the range of 9 to 13 at a liquid temperature of 25° C. as a standard with sodium hydroxide put the hydroxide particles containing nickel obtained in the manner as described above. After putting the nickel-containing hydroxide particle, a cobalt sulfate aqueous solution the concentration of which was 90 g/L was dropped while stirring the solution in the reaction tank with three blades (propeller type) with a stirring blade diameter of Φ70 under the low stirring condition of the stirring speed of 400 rpm (with as little stirring condition as possible to the extent that the nickel-containing hydroxide particles are curled up). A sodium hydroxide aqueous solution was dropped appropriately during the dropping to keep the pH of the reaction tank in the range of 9 to 13 at a liquid temperature of 25° C. as a standard to form a covering layer of cobalt hydroxide on a surface of the hydroxide particle, thereby obtaining a suspension of a nickel-containing hydroxide particle covered with cobalt hydroxide.

Oxidation Treatment on Nickel-Containing Hydroxide Particle Covered with Cobalt Hydroxide

The suspension of the nickel-containing hydroxide particle, the hydroxide particle covered with cobalt hydroxide obtained in the manner as described above underwent solid liquid separation treatment to obtain dried powder of hydroxide particles containing nickel, and to the dried powder containing the obtained hydroxide particles containing nickel was added and mixed a sodium hydroxide aqueous solution of 48% by mass, and the mixture was heated and dried at 120° C. for 30 minutes for oxidation treatment. In the oxidation treatment, the cobalt hydroxide in the covering layer formed on the surface of the nickel-containing hydroxide particle was oxidized to be cobalt oxyhydroxide that was trivalent cobalt.

Solid-Liquid Separation and Drying Treatment Thereafter, each treatment of washing with water, dehydration, and drying was performed on the oxidation-treated dried powder to obtain a nickel-containing hydroxide particle covered with cobalt of Example 1.

### Comparative Example 1

A nickel-containing hydroxide particle covered with cobalt of Comparative Example 1 was obtained in the same manner as in Example 1 except that the solid liquid mixture was stirred with strong stirring of 1100 rpm, which was 2.75 times the number of rotation of stirring of Example 1 (under the condition that the solid liquid mixture was sufficiently mixed to a homogeneous state) upon forming a covering layer containing cobalt.

### Comparative Example 2

A nickel-containing hydroxide particle covered with cobalt of Comparative Example 2 was obtained in the same manner as in Example 1 except that the nickel-containing hydroxide particle in which zinc and cobalt were solid solubilized was obtained upon synthesis of the nickel-containing hydroxide particle, a solid liquid mixture was stirred with intermediate stirring of 800 rpm, which was 2.00 times the number of rotation of stirring of Example 1 (under the condition that the solid liquid mixture was mixed to a homogeneous state) and no ammonium sulfate solution was added upon forming a covering layer containing cobalt.

### Comparative Example 3

A nickel-containing hydroxide particle covered with cobalt of Comparative Example 3 was obtained in the same manner as in Example 1 except that the nickel-containing hydroxide particle in which magnesium and cobalt were solid solubilized was obtained upon synthesis of the nickel-containing hydroxide particle, a solid liquid mixture was stirred at strong stirring of 1100 rpm, which was 2.75 times the stirring speed of Example 1 (under the condition that the solid liquid mixture was sufficiently mixed to a homogeneous state) and no ammonium sulfate solution was added upon forming a covering layer containing cobalt.

Evaluation Items

(1) Average Particle Strength

For the obtained nickel-containing hydroxide particle covered with cobalt, the amount of displacement of the nickel-containing hydroxide particle covered with cobalt was measured by applying a test pressure (load) to a nickel-containing hydroxide particle covered with cobalt, selected at random by using a microcompression tester, “MCT-510” manufactured by Shimadzu Corporation. A test force (P) was determined as a pressure value at which the amount of displacement reached the largest while the test pressure remained almost constant, upon gradually increasing the test pressure, and then a particle strength (St) was calculated by using the formula of Hiramatsu et al. (Journal of the Japan Mining Industry Association, Vol. 81, (1965)) represented by the following formula (A). The average particle strength was calculated by having performed the above-described procedure 10 times from the average of 10 measurements of the particle strength.

St=2.8×P/(π×d×d) (d: composite hydroxide particle diameter) (A)

(2) D50

D50 of the obtained nickel-containing hydroxide particle covered with cobalt was measured with a particle size analyzer (“Microtrac MT3300 EXII” manufactured by Nikkiso Co., Ltd.) (the principle is based on a laser diffraction and scattering method.).

Measuring Conditions of the Particle Size Analyzer

A solvent: water, a solvent refractive index: 1.33, a particle refractive index: 1.55, a transmittance 80±5%, a dispersion medium: 10.0 wt % of sodium hexametaphosphate aqueous solution.

(3) Tap Density (TD)

The tap density of the obtained nickel-containing hydroxide particle covered with cobalt was measured by a constant volume measurement method, which is one of the methods described in JIS R1628 by using a tap denser (“KYT-4000”, SEISHIN KIGYO Co., Ltd.).

(4) Bulk Density (BD)

The bulk density of the obtained nickel-containing hydroxide particle covered with cobalt was measured by dropping a sample spontaneously into a container and filling the container with the sample, using the volume of the container and the mass of the sample.

(5) BET Specific Surface Area

One gram of the obtained nickel-containing hydroxide particle covered with cobalt was dried at 105° C. for 30 minutes in a nitrogen atmosphere, and then the BET specific surface area of the nickel-containing hydroxide particle covered with cobalt was measured by a one-point BET method using a specific surface area analyzer (Macsorb, Mountech Co., Ltd.).

(6) Volume Resistivity

The volume resistivity (Q-cm) of the obtained nickel-containing hydroxide particles covered with cobalt was measured under the following conditions by using a powder resistivity system (Loresta) MCP-PD51, manufactured by Mitsubishi Chemical Analytec Co., Ltd.
Probe used: Four-point probe
Electrode spacing: 3.0 mm
Electrode radius: 0.7 mm
Sample radius: 10.0 mm
Sample mass: 3.00 g
Applied pressure: 20 kPa

(7) Shear Test

Six grams of the obtained nickel-containing hydroxide particles covered with cobalt were put in a barrel-type container, a pulverization medium with a diameter of 4.5 cm was put, and then pulverization treatment was performed for 10 minutes by using a vibrating cup mill (“MC-4A”, manufactured by ITO CORPORATION). D20 (unit: μm) values of the nickel-containing hydroxide particles covered with cobalt before and after the pulverization treatment were measured, and a change ratio of D20 {1−(D20 after the pulverization treatment/D20 before the pulverization treatment)}×100 was evaluated with the change ratio of Example 1 as 100%. It is noted that D20 was measured in the same manner as D50 described above.

For the obtained nickel-containing hydroxide particle covered with cobalt, the ratio of the mass of the nickel-containing hydroxide particle covered with cobalt to the mass of cobalt in the covering layer was determined by having dissolved the nickel-containing hydroxide particles in hydrochloric acid and then using an inductively coupled plasma emission spectrometer (“Optima7300 DV” manufactured by Perkin Elmer Japan, Co., Ltd.).

The results of the average particle strengths are shown in Table 1 below, and the results of D50, the tap density (TD), bulk density (BD), BET specific surface area, volume resistivity, and the ratio of the mass of cobalt in the nickel-containing hydroxide particle to the mass of cobalt in the covering layer are shown in Table 2 below, and the results of the shear test are shown in Table 3 below.

TABLE 1

| | Average | Average particle diameter of particle |
|---|---|---|
| | particle | subjected to strength measurement |
| | strength (MPa) | (μm) |
| Example 1 | 72.4 | 11.32 |
| Comparative | 61.5 | 11.43 |
| Example 1 | | |
| Comparative | 54.7 | 10.49 |
| Example 2 | | |
| Comparative | 63.7 | 11.16 |
| Example 3 | | |

TABLE 2

| | | Example | Comparative | Comparative | Comparative |
|---|---|---|---|---|---|
| | Unit | 1 | Example 1 | Example 2 | Example 3 |
| D50 | μm | 11.3 | 10.0 | 11.5 | 12.3 |
| Tap density (TD) | g/cm³ | 2.09 | 2.19 | 2.33 | 2.20 |
| Bulk density (BD) | g/cm³ | 1.46 | 1.51 | 1.70 | 1.69 |
| BET specific surface area | m²/g | 13.1 | 12.8 | 10.2 | 10.5 |
| Volume resistivity | Q · cm | 3.91 | 41.5 | 11.1 | 42.3 |
| Ratio of mass of cobalt in | — | 0.0238 | 0.0240 | 0.2674 | 0.4290 |
| nickel-containing hydroxide | | | | | |
| particle to mass of cobalt in | | | | | |
| covering layer | | | | | |

TABLE 3

| | Example | Comparative | Comparative | Comparative |
|---|---|---|---|---|
| | 1 | Example 1 | Example 2 | Example 3 |
| Change ratio | 100 | 129 | 148 | 148 |
| of D20 (%) | | | | |

From Table 1 above, it was found that in Example 1 in which the particle was fabricated by feeding the complexing agent and stirring at the low speed condition (with as little agitation as possible to the extent that the particles were curled up), a nickel-containing hydroxide particle covered with cobalt having an average particle strength of 72.4 MPa for D50 of 11.32 μm, was obtained, which exhibited an excellent particle strength while allowing an electrolytic solution to be permeated smoothly.

Moreover, from Table 2 above, it was found that Example 1 exhibited the volume resistivity of 3.91 Ω·cm, which indicated improvements in the electrical conductivity, enabling the electrical conductivity of a positive electrode active material to be maintained even when high loads were applied to a secondary battery, as a result of which the excellent battery characteristics could be obtained. Moreover, Example 1 exhibited the ratio of the mass of cobalt in the nickel-containing hydroxide particle to the mass of cobalt in the covering layer containing cobalt oxyhydroxide of 0.0238. Further, Example 1 could obtain D50, the tap density (TD), bulk density (BD), and BET specific surface area, which were all comparable to those of conventional products, thereby not impairing the properties except for the particle strength and the volume resistivity.

From Table 1 above, on the other hand, it was found that Comparative Example 1 in which the particle was fabricated by feeding the complexing agent and stirring with strong stirring of the number of rotation of stirring of 1,100 rpm (the condition in which the solid liquid mixture was sufficiently mixed to a homogeneous state), instead of by feeding the complexing agent and stirring under the low stirring condition of the number of rotation of stirring of 400 rpm (the stirring condition of as little agitation as possible to the extent that the particles were curled up), had an average particle strength of 61.5 MPa for D50 of 11.43 μm, Comparative example 2 in which the particle was fabricated by feeding no complexing agent and stirring with intermediate stirring of the number of rotation of stirring of 800 rpm (the condition in which the solid liquid mixture was mixed to a homogeneous state), instead of by stirring under the low stirring condition (the stirring condition of as little agitation as possible to the extent that the particles were curled up), had an average particle strength of 54.7 MPa for D50 of 10.49 μm, and Comparative Example 3 in which the particle was fabricated by feeding no complexing agent and stirring with strong stirring of the number of rotation of stirring of 1,100 rpm (the condition in which the solid liquid mixture was sufficiently mixed to a homogeneous state), instead of by stirring under the low stirring condition (the stirring condition of as little agitation as possible to the extent that the particles were curled up), had an average particle strength of 63.7 MPa for D50 of 11.16 μm, and each of the above-described average particle strengths was found to be less than 65.0 MPa in spite for the same degree of D50, thereby not enabling the nickel-containing hydroxide particle covered with cobalt having an excellent particle strength to be obtained.

Moreover, Table 2 above shows that Comparative Example 1 had volume resistivity of 41.5 Ω·cm, Comparative Example 2 had volume resistivity of 11.1 Ω·cm, and Comparative Example 3 had volume resistivity of 42.3 Ω·cm, all of which exceeded 10.0 Ω·cm, thereby not enabling the excellent electrical conductivity to be obtained. Further, Comparative Examples 1 to 3 each exhibited the ratio of the mass of cobalt in the nickel-containing hydroxide particle to the mass of cobalt in the covering layer containing cobalt oxyhydroxide of 0.0240 or more.

Further, Table 3 above shows that the change ratio in D20 before and after the pulverization treatment was 129% in Comparative Example 1, 148% in Comparative Examples 2 and 3, with the change ratio in D20 of Example 1 as 100%, and Example 1 inhibited the fine powder of the nickel-containing hydroxide particle covered with cobalt from being generated, however, Comparative Examples 1 to 3 could not inhibit the fine powder of the nickel-containing hydroxide particle covered with cobalt from being generated.

The nickel-containing hydroxide particle covered with cobalt of the present disclosure, having an excellent particle strength, can prevent cracks and fissures in the particle and fine powder from being generated, thereby enabling utilization in a wide field of secondary batteries, and the nickel-containing hydroxide particle covered with cobalt of the present disclosure is highly valuable in the field of, for example, nickel metal hydride secondary batteries, which require high battery characteristics under high load environments, such as higher output and improvements in utilization rate.

What is claimed is:

1. A nickel-containing hydroxide particle covered with cobalt, comprising a covering layer comprising cobalt oxyhydroxide formed on a nickel-containing hydroxide particle,
wherein an average particle strength is 65.0 MPa or more and 100.0 MPa or less for a particle diameter with a cumulative volume percentage of 50% by volume (D50) of 10.0 μm or larger and 11.5 μm or smaller.

2. The nickel-containing hydroxide particle covered with cobalt according to claim 1, wherein the covering layer comprising cobalt oxyhydroxide comprises cobalt oxyhydroxide in an amount of 70% by mass or more.

3. The nickel-containing hydroxide particle covered with cobalt according to claim 1, wherein a volume resistivity is 0.4 Ω·cm or more and 10.0 Ω·cm or less.

4. The nickel-containing hydroxide particle covered with cobalt according to claim 2, wherein a volume resistivity is 0.4 Ω·cm or more and 10.0 Ω·cm or less.

5. The nickel-containing hydroxide particle covered with cobalt according to claim 1, wherein the nickel-containing hydroxide particle comprises zinc.

6. The nickel-containing hydroxide particle covered with cobalt according to claim 2, wherein the nickel-containing hydroxide particle comprises zinc.

7. The nickel-containing hydroxide particle covered with cobalt according to claim 3, wherein the nickel-containing hydroxide particle comprises zinc.

8. The nickel-containing hydroxide particle covered with cobalt according to claim 5, wherein a ratio of a mass of cobalt in the nickel-containing hydroxide particle to a mass of cobalt in the covering layer comprising cobalt oxyhydroxide is 0.0001 or more and 0.0239 or less.

9. The nickel-containing hydroxide particle covered with cobalt according to claim 5, wherein the nickel-containing hydroxide particle comprises nickel (Ni), zinc (Zn), and one or more additive metal elements M selected from the group consisting of cobalt (Co) and magnesium (Mg), and a ratio by mole of nickel:zinc:additive metal element M is 100−x−y:x:y, where 1.50≤x≤9.00 and 0.00≤y≤3.00.

10. The nickel-containing hydroxide particle covered with cobalt according to claim 8, wherein the nickel-containing hydroxide particle comprises nickel (Ni), zinc (Zn), and one or more additive metal elements M selected from the group consisting of cobalt (Co) and magnesium (Mg), and a ratio by mole of nickel:zinc:additive metal element M is 100−x−y:x:y, where 1.50≤x≤9.00 and 0.00≤y≤3.00.

11. The nickel-containing hydroxide particle covered with cobalt according to claim 1, which is for a positive electrode active material of a nickel metal hydride secondary battery.

12. A positive electrode, having the nickel-containing hydroxide particle covered with cobalt according to claim 1 and a metal foil current collector.

13. A nickel metal hydride secondary battery comprising the positive electrode according to claim 12.
